(19) United States
(12) Patent Application Publication
(10) Pub. No.: US 2025/0139729 A1
(43) Pub. Date: May 1, 2025

(54) MOVEMENT SUPPORT SYSTEM

(71) Applicant: HONDA MOTOR CO., LTD., Tokyo (JP)

(72) Inventors: Yutaka Yoshida, Wako-shi (JP); Mitsutake Ando, Wako-shi (JP)

(21) Appl. No.: 18/921,435

(22) Filed: Oct. 21, 2024

(30) Foreign Application Priority Data
Oct. 30, 2023 (JP) 2023-185417

(51) Int. Cl. G06Q 50/40

(52) U.S. Cl. CPC G06Q 50/40

(57) ABSTRACT

A movement support system includes: an action plan information acquisition unit that acquires action plan information indicating an action plan of a user including movement by a first mobile body; a first target object information recognition unit that recognizes, based on the action plan information, a first target object used by the user after movement by the first mobile body, and a first target point and a first target time in which the first target object is scheduled to be used; and a transport service proposal unit that transmits, to a user terminal used by the user, first transport service proposal information that proposes use of a first transport service that transports the first target object from a first prescribed point to the first target point by the first target time by using a second mobile body other than the first mobile body.

### INCORPORATION BY REFERENCE

The present application claims priority under 35 U.S.C. § 119 to Japanese Patent Application No. 2023-185417 filed on Oct. 30, 2023. The content of the application is incorporated herein by reference in its entirety.

### BACKGROUND OF THE INVENTION

### Field of the Invention

The present invention relates to a movement support system.

### Description of the Related Art

A payload management system has conventionally been proposed which determines whether to transport the luggage of a user by an electronic vertical take-off and landing aircraft (eVTOL) on which the user boards or to separately send the luggage by vehicles other than the eVTOL (see, for example, US Patent Application Publication No. 20220067616).

In the payload management system, when it is not possible to transport both a passenger and his/her luggage together by an eVTOL, the luggage is separately sent by vehicles other than the eVTOL.

In the payload management system, whether or not to separately send the luggage of the user is determined in accordance with the gravitational force or size of the luggage. In this case, even when the baggage is to be used after arrival at a destination, the user needs to carry the luggage into the eVTOL as baggage, which disadvantageously lowers the convenience in the actions of the user associated with movement by mobile bodies.

The present invention has been made in view of such background circumstances, and it is an object of the present invention to provide a movement support system capable of enhancing the convenience in the actions of a user associated with movement by mobile bodies.

### SUMMARY OF THE INVENTION

As an aspect for accomplishing the above object, there may be provided a movement support system, including: an action plan information acquisition unit that acquires action plan information indicating an action plan of a user including movement by a first mobile body; a first target object information recognition unit that recognizes, based on the action plan information, a first target object used by the user after movement by the first mobile body, and a first target point and a first target time in which the first target object is scheduled to be used; and a transport service proposal unit that transmits, to a user terminal used by the user, first transport service proposal information that proposes use of a first transport service that transports the first target object from a first prescribed point to the first target point by the first target time by using a second mobile body other than the first mobile body.

The movement support system may include a first transport service corresponding unit that executes first transport service corresponding processing for implementing the first transport service, upon receiving first transport service request information that requests use of the first transport service, the first transport service request information being transmitted from the user terminal.

In the movement support system, the first target object information recognition unit may exclude from the first target object a target object that is scheduled to be used within a prescribed time from end of movement by the first mobile body and that is also carriable into the first mobile body, even though the target object is used after movement of the first mobile body.

In the movement support system, the first target object information recognition unit may preferentially recognize as the first target object a target object that is not sendable with the user by the first mobile body.

The movement support system may include a second target object information recognition unit that recognizes, based on the action plan information, a second target object that is used by an action of the user corresponding to the action plan and that is not scheduled to be used after the use in the action plan, and a second target point and a second target time in which pickup of the second target object that has been used is possible, in which the transport service proposal unit may transmit, to the user terminal, second transport service proposal information that proposes use of a second transport service that picks up the second target object in the second target point after the second target time and transports the second target object from the second target point to a second prescribed point by a third mobile body.

The movement support system may include a second transport service corresponding unit that executes second transport service corresponding processing for implementing the second transport service, upon receiving second transport service request information that requests use of the second transport service, the second transport service request information being transmitted from the user terminal.

In the movement support system, the transport service proposal unit may transmit, to the user terminal, the second transport service proposal information that proposes use of the second transport service for cleaning the second target object that has been used by the user and then transporting the second target object to the second prescribed point.

The movement support system is capable of enhancing the convenience of user's actions associated with movement by mobile bodies.

### BRIEF DESCRIPTION OF THE DRAWINGS

FIG. 1 is an explanatory view of an aspect where a movement support system supports movement of a user;

FIG. 2 is a configuration diagram of the movement support system;

FIG. 3 is a first flowchart of transport service proposal processing; and

FIG. 4 is a second flowchart of the transport service proposal processing.

### DETAILED DESCRIPTION OF THE INVENTION

### 1. Aspect of Movement Support

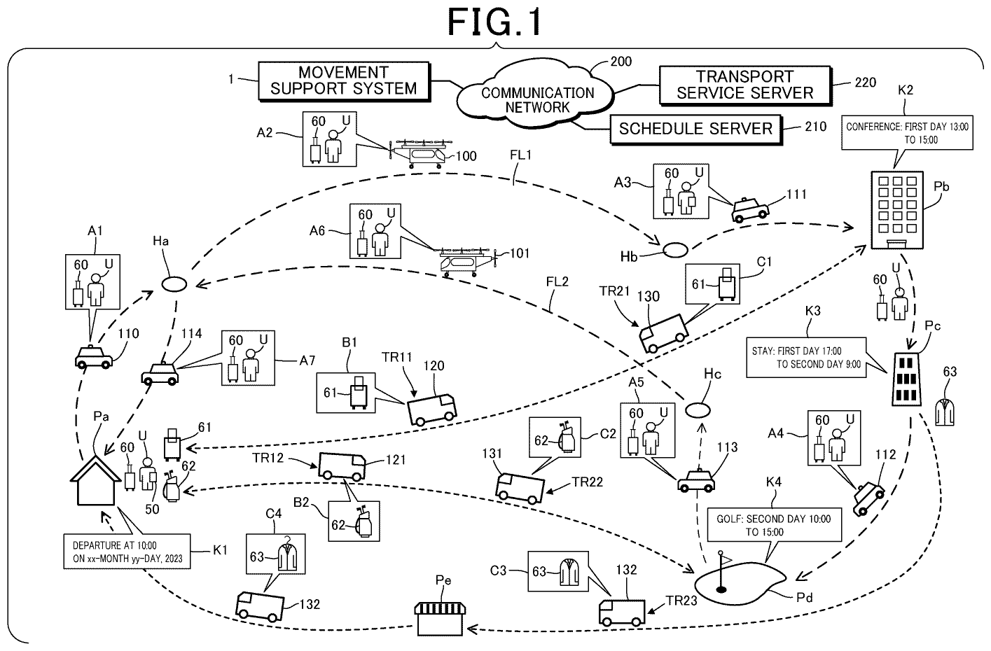

The aspect of a movement support system 1 of a present embodiment that supports the movement of a user U is described with reference to FIG. 1. The movement support system 1 performs communication among a user terminal 50 used by the user U, a schedule server 210, and a transport service server 220 through a communication network 200 to support the movement of the user U.

The movement support system 1, the schedule server 210, and the transport service server 220 are computer systems each including a processor, a memory, a communication unit, or the like. The user terminal 50 is a terminal having a communication function, such as smartphones, mobile phones, tablet terminals, or the like.

In the example shown in FIG. 1, the user U has action plans (1) to (8) for two days, including movement by aircrafts 100 and 101 as shown below. The aircrafts 100 and 101 are vertical take-off and landing type aircrafts, such as vertical take-off and landing (VTOL) aircrafts, which can accommodate up to about four passengers, for example. The aircraft 100 corresponds to the first mobile body in the present disclosure.
(1) Leave home Pa at 10:00 on xx-month yy-day, 2023 (first day) as indicated in a balloon K1, and move to a take-off/landing port Ha by a vehicle 110 (such as a taxi).
(2) Move from the take-off/landing port Ha to a take-off/landing port Hb through flight FL1 by the aircraft 100.
(3) To participate in a conference indicated by a balloon K2 (13:00 to 15:00 on the first day), move from the take-off/landing port Hb to a conference center Pb where the conference is to be held by a vehicle 111.
(4) Move from the conference center Pb to a hotel Pc on foot and stay at the Hotel Pc (check in at 17:00, and check out at 9:00 on the second day).
(5) To play golf, move from the hotel Pc to a golf course Pd by a vehicle 112 and play golf (10:00 to 15:00).
(6) To use a return flight FL2, move from the golf course Pd to the take-off/landing port Hc by a vehicle 113 (such as a taxi).
(7) Move from the take-off/landing port Hc to the take-off/landing port Ha through flight FL2 by the aircraft 101.
(8) Move from the take-off/landing port Ha to the home Pa by a vehicle 114 (such as a taxi) to return home.

In the action plans, the conference to be held at the conference center Pb and the golf to be played at the golf course Pd are planned as events in which the user U participates. The user U needs to carry a large bag 61, containing materials and equipment to be used in the conference, to the conference center Pb, and also needs to carry the golf bag 62 containing golf equipment to the golf course Pd.

It is an excessive burden for the user U to carry with him or her the large bag 61 and the golf bag 62 as well as a small bag 60 containing personal belongings during movement including the flights FL1 and FL2, which results in extreme deterioration in the convenience of the movement of the user U. Accordingly, the movement support system 1 acquires action plan information indicating the action plans of the user U from the schedule server 210 or the user terminal 50, and recognizes a target object used by the user U in the action plans.

The movement support system 1 proposes to the user U the use of first transport services TR11 and TR12 shown below, which transport a first target object (the large bag 61 and the golf bag 62 in the example of FIG. 1) to be used after movement by the flight FL1, separately from the movement of the user U.
TR11 . . . as shown by a balloon B1, the large bag 61 is transported from the home Pa of the user U (corresponding to the first prescribed point in the present disclosure) to the conference center Pb by a first target time that is before 13:00 when the conference is held, by using a transport vehicle 120 (corresponding to the second mobile body in the present disclosure)
TR12 . . . as shown by a balloon B2, the golf bag 62 is transported from the home Pa of the user U to the golf course Pd by a golf play start time (10:00 on the second day) by using a transport vehicle 121 (corresponding to the second mobile body in the present disclosure).

The movement support system 1 also recognizes a second target object that is not scheduled to be used again after use by the user U in the action plans. The movement support system 1 executes processing to propose to the user U a second transport service for receiving and delivering the used second target object to the home Pa. In the example in FIG. 1, the large bag 61 containing materials and equipment used in the conference, the golf bag 62 containing golf equipment used in the golf play, and a suit 63 worn by the user U in the conference are recognized as the second target objects.

The movement support system 1 proposes to the user U second transport services TR21, TR22, and TR23 shown below:
TR21 . . . as shown by a balloon C1, the large bag 61 containing the conference materials and equipment that have been used is transported from the conference center Pb to the home Pa of the user U (corresponding to the second prescribed point in the present disclosure) by a transport vehicle 130 (corresponding to the third mobile body in the present disclosure)
TR22 . . . as shown by a balloon C2, the golf bag 62 containing the golf equipment that has been used is transported from the golf course Pd to the home Pa of the user U by a transport vehicle 131 (corresponding to the third mobile body in the present disclosure); and
TR23 . . . as shown by a balloon C3, the suit 63 worn by the user U in the conference is transported from the hotel Pc to the home Pa of the user U by a transport vehicle 132 (corresponding to the third mobile body in the present disclosure). The user U can optionally request to clean the suit 63 at a dry cleaner Pe and then to deliver the suit 63 to the home Pa.

Similarly, the user U can also request to clean golf clubs and golf shoes contained in the golf bag 62 and then to deliver them to the home Pa.

When the user U uses the first transport services TR11 and TR12 and the second transport services TR21, TR22, and TR23, the user U can carry with him or her only the small bag 60 in the action plans as shown by balloons A1 to A7. This makes it possible to enhance the convenience in the movement of the user U.

### 2. Configuration of Movement Support System

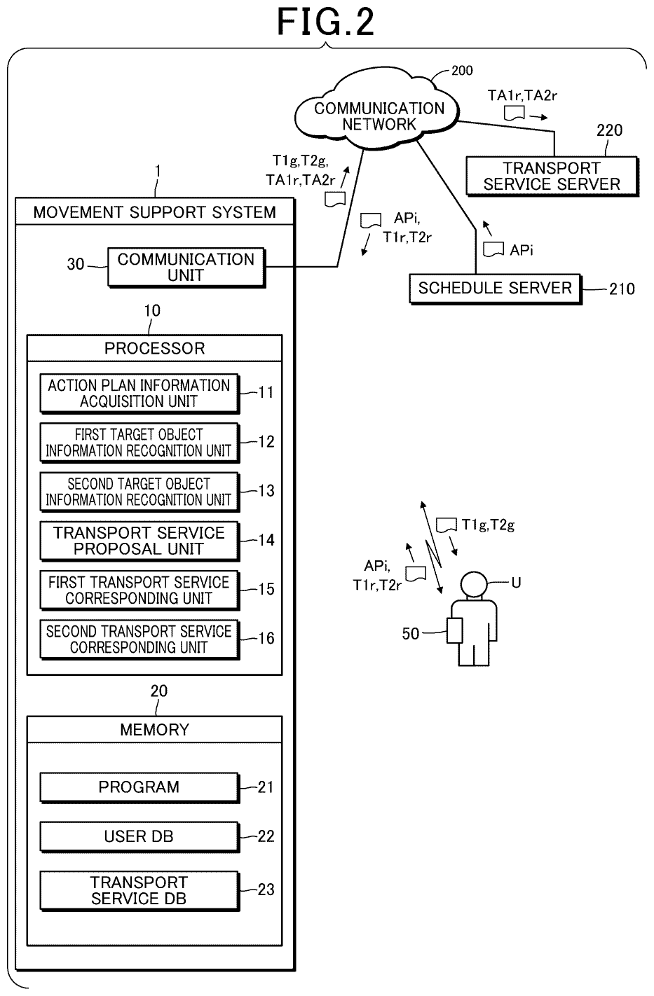

The configuration of the movement support system 1 is described with reference to FIG. 2. The movement support system 1 is a computer system including a processor 10, a memory 20, a communication unit 30, or the like. The movement support system 1, as described above, uses the communication unit 30 to perform communication among the user terminal 50, the schedule server 210, and the transport service server 220 through the communication network 200.

The memory 20 stores a program 21 for controlling the movement support system 1, a user database (DB) registered with information about the user U who applied for the use of the services provided by the movement support system 1, and a transport service DB 23 registered with information about transporters that implement the first transport service and the second transport service. The user U requests the aforementioned first transport service and second transport service by accessing the movement support system 1 using a movement support application (an application program) installed on the user terminal 50.

The processor 10 reads and executes the program 21 so as to function as an action plan information acquisition unit 11, a first target object information recognition unit 12, a second target object information recognition unit 13, a transport service proposal unit 14, a first transport service corresponding unit 15, and a second transport service corresponding unit 16.

The action plan information acquisition unit 11 accesses the schedule server 210 and acquires action plan information APi including the action plans relating to the user U. The user U uses a schedule application installed on the user terminal 50 to create his or her own action plans, and the information about the created action plans is uploaded to the schedule server 210 and stored in the schedule server 210. Alternatively, the action plan information acquisition unit 11 acquires the action plan information APi relating to the user U by receiving the action plan information APi transmitted from the user terminal 50.

Based on the action plan information APi relating to the user U, the first target object information recognition unit 12 recognizes the action plans including the movement of the user U by aircrafts (corresponding to the first mobile body in the present disclosure). In the example shown in FIG. 1, the action plans for two days including the movement by the aircrafts 100 and 101 are recognized. In the action plans, the first target object information recognition unit 12 recognizes a first target object used after movement by the aircraft 100, and a use point and a use time of the first target object. In the example shown in FIG. 1, the first target object information recognition unit 12 recognizes the large bag 61 and the golf bag 62 as the first target objects, and recognizes following information:
Large bag 61 . . . the use point is the conference center Pb, and the use time is 13:00 or later on the first day; and
Golf bag 62 . . . the use point is the golf course Pd, and the use time is 10:00 or later on the second day.

Here, following search conditions 1 and 2 may be set for the first target object information recognition unit 12 to recognize the first target objects.
Condition 1: from the perspective of accommodation capacity and transportation capacity of the aircraft 100, a target object not sendable with the user U by the aircraft 100 is preferentially recognized as the first target object.
Condition 2: a target object scheduled to be used within a prescribed time after the end of the movement is excluded from the first target object, even though the target object is used after the movement by the aircraft 100.

Based on the action plan information APi of the user U, the second target object information recognition unit 13 recognizes a second target object that is not scheduled to be used again after use, in the action plans of the user U. In the example shown in FIG. 1, the second target object information recognition unit 13 recognizes the large bag 61, the golf bag 62, and the suit 63 as the second target objects, and recognizes following information:
Large bag 61: a pickup point is the conference center Pb, and a pickup time is 15:00 or later on the first day;
Golf bag 62: the pickup point is the golf course Pd, and the pickup time is 15:00 or later on the second day; and
Suit 63: the pickup point is the hotel Pc, and the pickup time is 17:00 or later on the second day.

The transport service proposal unit 14 transmits to the user terminal 50 first transport service proposal information T1g that proposes the use of the first transport service that is for separately sending the first target object recognized by the first target object information recognition unit 12. The transport service proposal unit 14 also transmits to the user terminal 50 second transport service proposal information T2g that proposes the use of the second transport service that is for separately sending the second target object recognized by the second target object information recognition unit 13. In the example of FIG. 1, as described above, the first transport service proposal information T1g that proposes the use of the first transport services TR11 and TR12, and the second transport service proposal information that proposes the use of the second transport services TR21, TR22, and TR23 are transmitted to the user terminal 50.

When receiving the first transport service request information T1r transmitted from the user terminal 50 to request the use of the first transport service, the first transport service corresponding unit 15 executes the first transport service corresponding processing for implementing the requested first transport service. For example, when receiving the first transport service request information T1r for requesting the use of the first transport service TR11, the first transport service corresponding unit 15 makes arrangements by requesting transport service companies to pick up the large bag 61 at the home Pa before the time of departure of the user U from the home Pa (10:00 on xx month yy day, 2023) and to transport the large bag 61 to the conference center Pb by the start time of the conference (13:00 on the same day). Specifically, the first transport service corresponding unit 15 refers to the transport service DB 23 to extract a transport service company that can provide the first transport service TR11, and accesses the transport service server 220 operated by the extracted transport service company to execute the processing to request transportation arrangements.

When receiving the second transport service request information T2r transmitted from the user terminal 50 to request the use of the second transport service, the second transport service corresponding unit 16 executes the second transport service corresponding processing for implementing the requested second transport service. For example, when receiving the second transport service request information T2r to request the use of the second transport service TR23, the second transport service corresponding unit 16 makes arrangements by requesting a transport company to pick up the suit 63 at the hotel Pc (the second target point) at a second target time that is after the time when the user U checks in the hotel Pc (17:00 on the second day) and to transport the suit 63 to the home Pa of the user U. Specifically, the second transport service corresponding unit 16 refers to the transport service DB 23 to extract a transport service company that can provide the second transport service TR23, and accesses the transport service server 220 operated by the extracted transport service company to execute the processing to request transportation arrangements.

### 3. Transport Service Proposal Processing

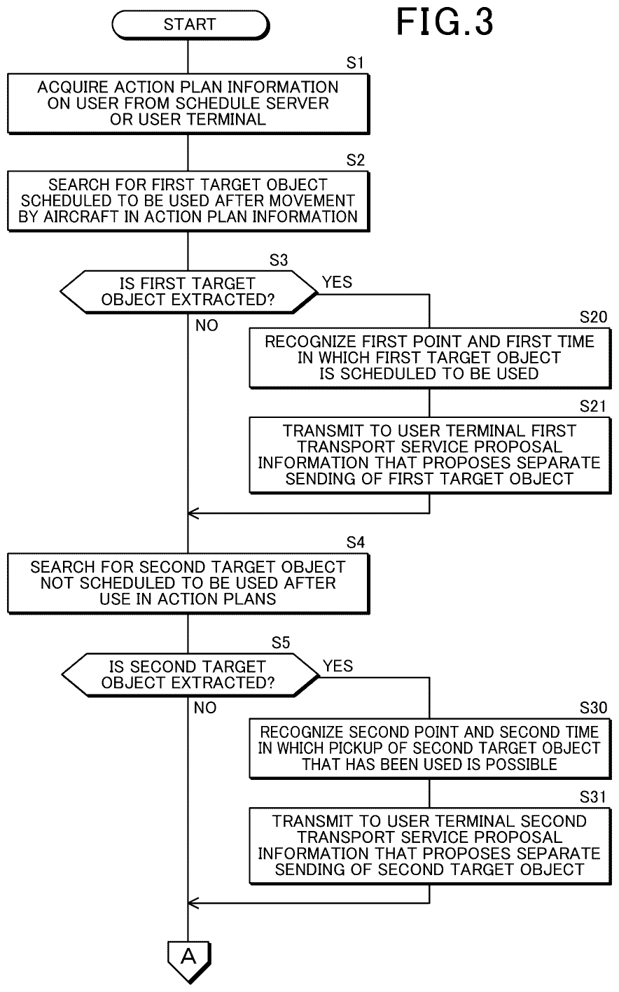

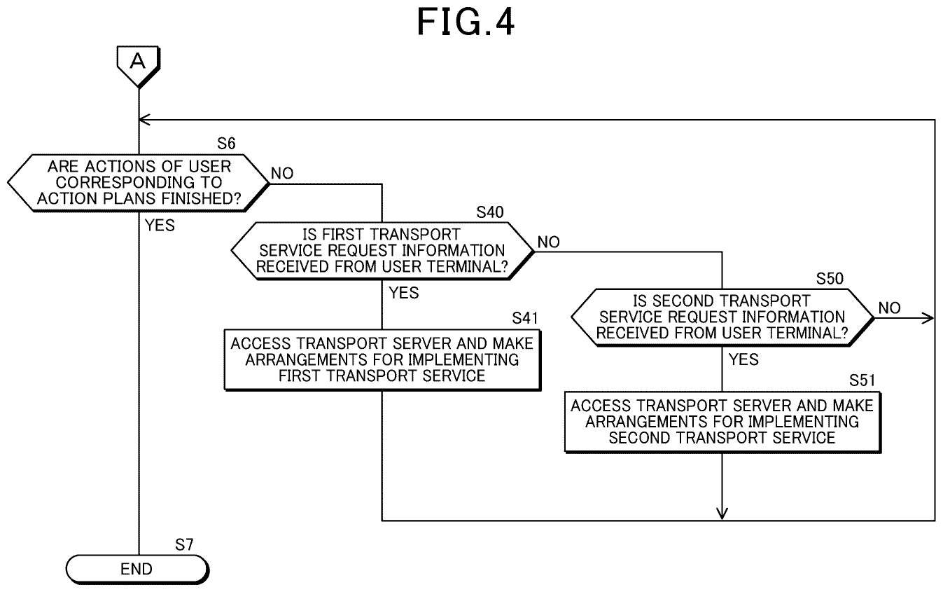

Description is given of the procedure for the transport service proposal processing executed by the movement support system 1 in the situation described with reference to FIGS. 1 and 2, based on the flowcharts shown in FIGS. 3 to 4.

In step S1 in FIG. 3, the action plan information acquisition unit 11 acquires action plan information APi indicating the action plans of the user U by accessing the schedule server 210 or through communication with the user terminal 50. In subsequent step S2, the first target object information recognition unit 12 searches for a first target object in the action plan information APi, the first target object being scheduled to be used after movement by the aircraft.

In next step S3, the first target object information recognition unit 12 advances the processing to step S20 when the first target object is extracted, and advances the processing to step S4 when no first target object is extracted. In the example in FIG. 1, the large bag 61 and the golf bag 62 are extracted as the first target objects. In step S20, the transport service proposal unit 14 recognizes a first point and a first time in which the first target object is scheduled to be used, from the action plans.

In next step S21, the transport service proposal unit 14 transmits to the user terminal 50 the first transport service proposal information T1g that proposes separate sending of the first target object, and advances the processing to step S4. In the example in FIG. 1, the transport service proposal unit 14 transmits to the user terminal 50 the first transport service proposal information T1g that proposes the use of the first transport services R11 and R12.

In next step S4, the second target object information recognition unit 13 searches for a second target object in the action plan information APi, the second target object being not scheduled to be used again after use by the user U in the action plans. In subsequent step S5, the second target object information recognition unit 13 advances the processing to step S30 when a second target object is extracted, and advances the processing to step S6 in FIG. 4 when no second target object is extracted.

In the example in FIG. 1, the large bag 61, the golf bag 62, and the suit 63 are extracted as the second target objects. In step S30, the transport service proposal unit 14 recognizes a second target point and a second time point in which the second target object can be picked up, from the action plans. In next step S31, the transport service proposal unit 14 transmits to the user terminal 50 the second transport service proposal information T2g that proposes separate sending of the second target object, and advances processing to step S6 in FIG. 4. In the example in FIG. 1, the transport service proposal unit 14 transmits to the user terminal 50 the second transport service proposal information T2g that proposes the use of the second transport services TR21, TR22, and TR23.

In step S6 in FIG. 4, the transport service proposal unit 14 determines whether or not the actions of the user U corresponding to the action plans are finished based on position information or the like on the user terminal 50 that is transmitted from the user terminal 50. The transport service proposal unit 14 then advances the processing to step S7 when the actions of the user U corresponding to the action plans are finished, and advances the processing to step S40 when the actions of the user U corresponding to the action plans are not finished.

In step S40, the first transport service corresponding unit 15 advances the processing to step S41 when receiving from the user terminal 50 the first transport service request information T1r that requests the use of the first transport service, and advances the processing to step S50 when the first transport service corresponding unit 15 does not receive the first transport service request information T1r. In step S41, the first transport service corresponding unit 15 accesses the transport service server 220 to make arrangements to implement the first transport service as described above, and advances the processing to step S6.

In step S50, the second transport service corresponding unit 16 advances the processing to step S51 when receiving from the user terminal 50 the second transport service request information T2r that requests the use of the second transport service, and advances the processing to step S6 when the second transport service corresponding unit 16 does not receive the second transport service request information T2r. In step S51, the second transport service corresponding unit 16 accesses the transport service server 220 to make arrangements to implement the second transport service as described above, and advances the processing to step S6.

### 4. Other Embodiments

In the above embodiment, the aircrafts 100 and 101 are illustrated as the first mobile bodies in the present disclosure, though the first mobile body in the present disclosure may be any other types of mobile bodies, such as railways, ships, vehicles, and the like. Although the vehicles 120 and 121 are illustrated as the second mobile bodies of the present disclosure, and the vehicles 130, 131, and 132 are illustrated as the third mobile bodies of the present disclosure, the first mobile body and the second mobile body in the present disclosure may be any other types of mobile bodies, other than vehicles.

The above embodiment includes the first transport service corresponding unit 15 that makes arrangements to implement the first transport service. However, the first transport service corresponding unit 15 may be omitted, and the movement support system 1 may be configured to perform only up to the proposal of the use of the first transport service by the transport service proposal unit 14.

The above embodiment includes the second target object information recognition unit 13 that proposes the use of the second transport service by the transport service proposal unit 14 for the second target object that is not scheduled to be used again. However, the second target object information recognition unit 13 may be omitted, and the movement support system 1 may be configured not to propose the second transport service.

The above embodiment includes the second transport service corresponding unit 16 that makes arrangements to implement the second transport service. However, the second transport service corresponding unit 16 may be omitted, and the movement support system 1 may be configured to perform only up to the proposal of the use of the second transport service by the transport service proposal unit 14.

For easy understanding of the present invention, FIG. 2 is a schematic diagram showing the functional configuration of the movement support system 1, which is categorized according to main processing contents, and the movement support system 1 may be configured according to other categories. The processing of each component member may be executed by a single hardware unit or may be executed by a plurality of hardware units. The processing by each component member shown in FIGS. 3 and 4 may be executed by a single program or may be executed by a plurality of programs.

### 5. Configurations Supported by Above Embodiment

The above embodiment is a specific example of the following configurations.

### (Configuration 1)

A movement support system, including: an action plan information acquisition unit that acquires action plan information indicating an action plan of a user including movement by a first mobile body; a first target object information recognition unit that recognizes, based on the action plan information, a first target object used by the user after movement by the first mobile body, and a first target point and a first target time in which the first target object is scheduled to be used; and a transport service proposal unit that transmits, to a user terminal used by the user, first transport service proposal information that proposes use of a first transport service that transports the first target object from a first prescribed point to the first target point by the first target time by using a second mobile body other than the first mobile body.

According to the movement support system in the configuration 1, the use of the first transport service, in which the first target object used by the user after movement by the first mobile body is transported by the second mobile body, is proposed to the user. By using the first transport service, the user can move by using the first mobile object without possessing the first target object, which makes it possible to enhance the convenience in the actions of the user associated with movement by mobile bodies.

Note that “the first target object used by the user after movement by the first mobile body” in the configuration 1 includes a target object that is used by the user at the point, to which the user moves by another mobile body after moving by the first mobile body. For example, in FIG. 1, the user U leaves the aircraft 100 (first mobile body) at the take-off/landing port Hb and then moves to the conference center Pb by the vehicle 111, and the large bag 61 used by the user U at the conference center Pb corresponds to the first target object.

### (Configuration 2)

The movement support system according to the configuration 1 including a first transport service corresponding unit that executes first transport service corresponding processing for implementing the first transport service, upon receiving first transport service request information that requests use of the first transport service, the first transport service request information being transmitted from the user terminal.

The movement support system in the configuration 2 can swiftly make arrangements of the first transport service in response to the request for the first transport service from the user.

### (Configuration 3)

The movement support system according to the configuration 1 or the configuration 2, in which the first target object information recognition unit excludes from the first target object a target object that is scheduled to be used within a prescribed time from end of movement by the first mobile body and that is also carriable into the first mobile body, even though the target object is used after movement of the first mobile body.

The movement support system in the configuration 3 can avoid proposing the use of the first transport service, which is assumed to be less likely to be used, for the target objects that are immediately used after the movement by the first mobile body.

### (Configuration 4)

The movement support system according to any one of the configuration 1 to the configuration 3, in which the first target object information recognition unit preferentially recognizes as the first target object a target object that is not sendable with the user by the first mobile body.

The movement support system in the configuration 4 preferentially provides the user with the first transport service information for the target object not sendable with the user by the first mobile body, and thereby allows the user to easily make arrangements of transporting the target object that requires separate sending.

### (Configuration 5)

The movement support system according to any one of the configuration 1 to the configuration 4 includes a second target object information recognition unit that recognizes, based on the action plan information, a second target object that is used by an action of the user corresponding to the action plan and that is not scheduled to be used after the use in the action plan, and a second target point and a second target time in which pickup of the second target object that has been used is possible, in which the transport service proposal unit transmits, to the user terminal, second transport service proposal information that proposes use of a second transport service that picks up the second target object in the second target point after the second target time and transports the second target object from the second target point to a second prescribed point by a third mobile body.

The movement support system in the configuration 5 provides the user with information on the second transport service that is for transporting the second target object that has been used as scheduled in the action plan, by using the third mobile body. By using the second transport service, the user can separately send the second target object used as scheduled in the action plan, and this facilitates subsequent movement of the user.

### (Configuration 6)

The movement support system according to the configuration 5 including a second transport service corresponding unit that executes second transport service corresponding processing for implementing the second transport service, upon receiving second transport service request information that requests use of the second transport service, the second transport service request information being transmitted from the user terminal.

The movement support system in the configuration 6 can swiftly make arrangements of the second transport service in response to the request for the second transport service from the user.

### (Configuration 7)

The movement support system according to the configuration 5 or the configuration 6, in which the transport service proposal unit transmits, to the user terminal, second transport service proposal information that proposes use of the second transport service for cleaning the second target object that has been used by the user and then transporting the second target object to the second prescribed point.

According to the movement support system in the configuration 7, the user can receive the cleaned second target object, so that the user does not need to clean the second target object after the action plan is finished. As a result, the convenience of the user can be enhanced.

### REFERENCE SIGNS LIST

1 . . . Movement support system, 10 . . . Processor, 11 . . . Action plan information acquisition unit, 12 . . . First target object information recognition unit, 13 . . . Second target object information recognition unit, 14 . . . Transport service proposal unit, 15 . . . First transport service corresponding unit, 16 . . . Second transport service corresponding unit, 20 . . . Memory 21 . . . Program, 22 . . . User DB, 23 . . . Transport service DB, 30 . . . Communication unit, 50 . . . User terminal 61 . . . Large bag (first target object, second target object), 62 . . . Golf bag (first target object, second target object), 100 . . . Aircraft (first mobile body), 120, 121 . . . Transport vehicle (second mobile body), 130, 131, 132 . . . Transport vehicle (third mobile body), 200 . . . Communication network, 210 . . . Schedule server, 220 . . . Transport service server, U . . . User.

1. A movement support system, comprising:
an action plan information acquisition unit that acquires action plan information indicating an action plan of a user including movement by a first mobile body;
a first target object information recognition unit that recognizes, based on the action plan information, a first target object used by the user after movement by the first mobile body, and a first target point and a first target time in which the first target object is scheduled to be used; and
a transport service proposal unit that transmits, to a user terminal used by the user, first transport service proposal information that proposes use of a first transport service that transports the first target object from a first prescribed point to the first target point by the first target time by using a second mobile body other than the first mobile body.

2. The movement support system according to claim 1, comprising a first transport service corresponding unit that executes first transport service corresponding processing for implementing the first transport service, upon receiving first transport service request information that requests use of the first transport service, the first transport service request information being transmitted from the user terminal.

3. The movement support system according to claim 1, wherein
the first target object information recognition unit excludes from the first target object a target object that is scheduled to be used within a prescribed time from end of movement by the first mobile body and that is also carriable into the first mobile body, even though the target object is used after movement of the first mobile body.

4. The movement support system according to claim 1, wherein
the first target object information recognition unit preferentially recognizes as the first target object a target object that is not sendable by the first mobile body together with the user.

5. The movement support system according to claim 1, comprising a second target object information recognition unit that recognizes, based on the action plan information, a second target object that is used by an action of the user corresponding to the action plan and that is not scheduled to be used after the use in the action plan, and a second target point and a second target time in which pickup of the second target object that has been used is possible, wherein
the transport service proposal unit transmits, to the user terminal, second transport service proposal information that proposes use of a second transport service that picks up the second target object in the second target point after the second target time and transports the second target object from the second target point to a second prescribed point by a third mobile body.

6. The movement support system according to claim 5, comprising a second transport service corresponding unit that executes second transport service corresponding processing for implementing the second transport service, upon receiving second transport service request information that requests use of the second transport service, the second transport service request information being transmitted from the user terminal.

7. The movement support system according to claim 5, wherein
the transport service proposal unit transmits, to the user terminal, the second transport service proposal information that proposes use of the second transport service for cleaning the second target object that has been used by the user and then transporting the second target object to the second prescribed point.
